(19) United States
(12) Patent Application Publication
(10) Pub. No.: US 2004/0179817 A1
(43) Pub. Date: Sep. 16, 2004

(54) Method for searching and playing back video data based on caption-based information

(76) Inventor: Hung-Te Chou, Taipei (TW)

Correspondence Address: BIRCH STEWART KOLASCH & BIRCH, PO BOX 747, FALLS CHURCH, VA, 22040-0747, US

(21) Appl. No.: 10/796,964

(22) Filed: Mar. 11, 2004

(30) Foreign Application Priority Data
Mar. 14, 2003 (TW) 092105606

(51) Int. Cl. H04N 5/91; H04N 7/00

(52) U.S. Cl. 386/69; 386/70

(57) ABSTRACT

A method of searching and playing back video data based on caption-based information, first reads the caption-based information of video data and establishes a search table. The method performs searches according to the searching information entered by the user and lists all data that satisfy the requested words for the user to select. The video is then played according to the selected item. Therefore, the user can arbitrarily select a section of video data to play. This greatly simplifies the process of viewing video data.

### BACKGROUND OF THE INVENTION

1. Field of Invention

The invention relates to a method of playing video data applied in the field of information technology industry and, in particular, to a method of searching and playing video data based on the caption-based information.

2. Related Art

The video data storage has evolved from traditional videotapes to digital storage media, which has brought the people more plentiful and enjoyable entertainment. As for digital storage media, the video compact disk (VCD) has been developed in the early days, while the digital versatile disc (DVD) has been developed in the recent years.

The DVD is a new-generation digital storage medium, and has a similar appearance and size with the commonly-used optical discs. Because of its high storage capacity, the DVD plays an important role in the multimedia-related field. Take an audio/video (AV) DVD as an example, it has the video data stored in the MPEG-2 format, providing a fine image quality. In addition, the DVD provides the digital surround sound effects and captions in multi-languages so as to make the users have more various video playing options.

However, the video data in the DVD is played back in the conventional mode. For example, if a user wants to fast-forward or rewind the video data, the video data is searched and played according to its time location or data offset location. This is a very inconvenient searching and playing mode for users because the time location or the data offset location is an independent searching unit irrelevant to the content of the video data. Therefore, in order to have a specific section of the video data played, the user has to have the memory for the time location or data offset location corresponding to the specific section so that the user can use the time location or data offset location to find out the specific section for playing.

If the user does not remember the time location or data offset location for the specific section and cannot determine the starting point of the specific section of the video data, he or she has to gradually forward or rewind the video data so as to find out the specific section. This is very time-consuming.

In particular, for the video content of language learning, the user often remembers the voice-over, but has no idea about the time location or the data offset location of a specific section. Therefore, the conventional method for searching and playing back is obviously not helpful. It is thus imperative to solve this problem and make it easier and more convenient to searching and playing back the video data.

### SUMMARY OF THE INVENTION

In view of the foregoing, the invention provides a method of searching and playing back video based on caption-based information. Its primary objective is to use the correlation between words and video contents so that the user can arbitrarily and accurately find the desired video data section to play.

The disclosed method first reads in the caption-based information of the video data and establishes a search table. The method then generates a user interface for the user to operate. The user can enter the word(s) to be searched for. The system then looks up in the search table the word(s) entered by the user and lists all matching items. The user can select a desired item from the list shown in the user window interface. Afterwards, the system determines and plays the selected video data.

Being different from the searching mode in the prior art, the invention uses the search information entered by the user to search the desired video data section. The method starts playing the video according to the starting play queue information. Therefore, the user does not need to remember the time location or data offset location. The content based searching mode provided by the invention can facilitate video searching and playing.

Another objective of the invention is to provide a fast and accurate searching method. The disclosed method first reads in the caption-based information of the video data. Afterwards, the system performs video search key depression detection. When a search key is detected to be depressed, the system reads the time information of the current video data. According to the starting play queue information of the caption data, the method determines the playtime information. Finally, the video data are played according to the playtime information.

Just as the above-mentioned conventional search mode, a method of searching and playing video data by words according to the invention is as follows. When the user depresses a search key, the system uses the starting play queue information of the caption data as the base to play forward or rewind. Whenever the user depresses the search key, the system plays from the beginning of each sentence so that each section of video data being played is clear and complete. In particular, it is of great help for the video data disc of language learning to be searched and played according to the caption data.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the first embodiment of the disclosed method; and

FIG. 2 is a schematic view of the second embodiment of the disclosed method.

### DETAILED DESCRIPTION OF THE INVENTION

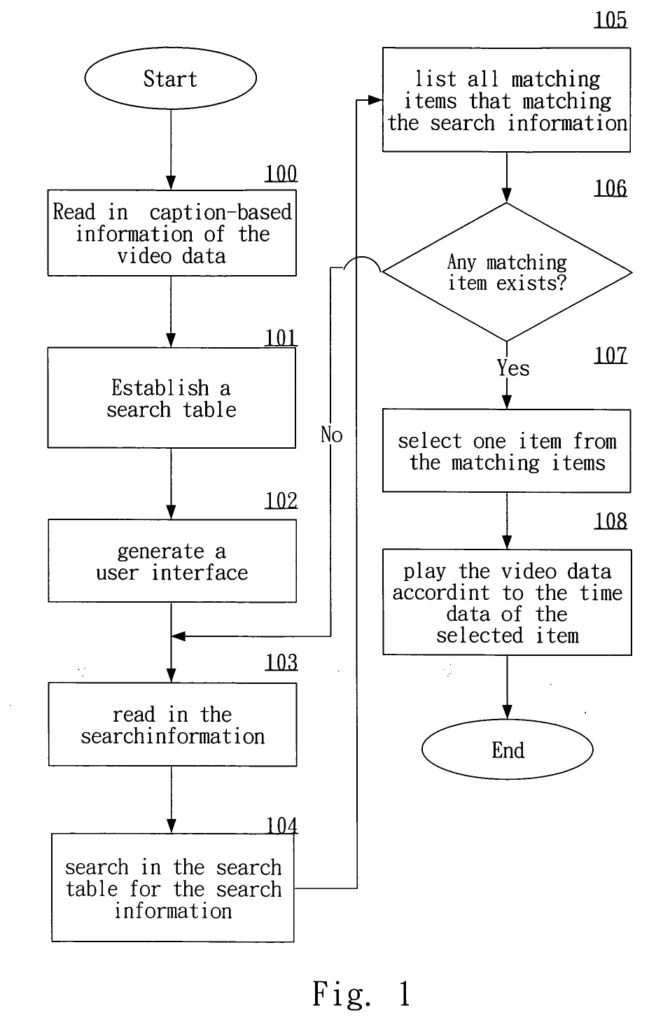

We use FIG. 1 to explain the main procedure in the disclosed method of playing video data by word searching. Normally, the video data in a multimedia disc include closed caption data or subtitle data of various languages. As shown in the drawing, the disclosed method first reads in the caption-based information of the video data(step 100) and establishes a search table accordingly (step 101). The search table contains more than one sentences and the corresponding starting play queue information. The starting play queue information can be either time location or data amount. The caption playing is actually performed according to the starting play queue information. The next step is to generate a user interface (step 102) for the user to perform various operations. The user enters search information in an input field of the user window interface for the system to read (step 103). According to the search information, the system searches in the search table (step 104) and lists all matching items (step 105). The matching items include several word data and the corresponding time data. They are listed in a selection table for the user to select. The system then checks matching item selected (step 106). If no item is selected, the procedure goes back to step 103. If the user selects an item (step 107), the system sets the play information according to the time data of the selected item and starts to play video data (step 108).

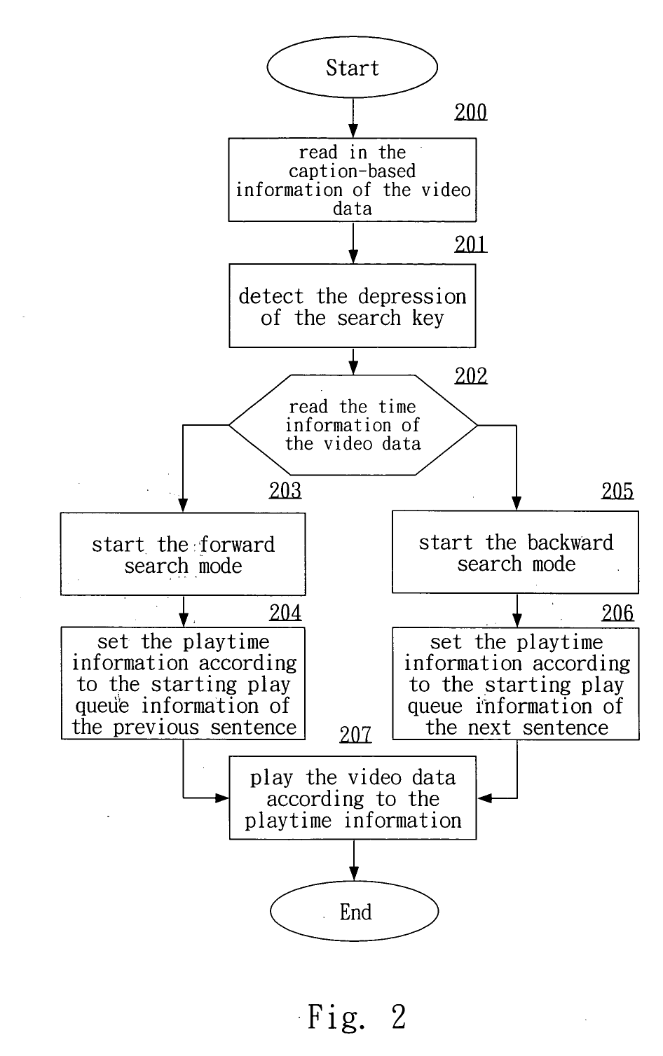

The invention further discloses another method of playing video data by word searching. The main objective is for the user to search video data from its caption-based information by depressing a search key. This provides a faster and more accurate search and play mode. As shown in FIG. 2, the method first reads in the caption-based information of video data (step 200). The caption data include several sentence data. Each sentence data has the corresponding starting play queue information and an item-attribute with a seekable video location of numerical type. Afterwards, the method performs a search key depression detection operation (step 201) and adjusts the video data playing operation. In fact, there are two search keys: one for playing forward and the other for playing backward. For different functions of the search keys, there are different procedures. If the forward search key is depressed, the method first reads the time information of the video data (step 202) and starts the forward search mode (step 203). The playtime is set according to the starting play queue information of the previous sentence (step 204). Finally, the video data are played according to the playtime information (step 207). If the backward search key is depressed, the method first reads the time information of the video data (step 202) and starts the backward search mode (step 205). The playtime is set according to the starting play queue information of the next sentence (step 206). Finally, the video data are played according to the playtime information (step 207).

According to the disclosed method, the starting play queue information of the caption data is the base for searching and playing forward or backward. The video data are played from the beginning of each sentence. As the user depresses the search key, the method plays sections of the video data in a clear and complete fashion.

Certain variations would be apparent to those skilled in the art, which variations are considered within the spirit and scope of the claimed invention.

What is claimed is:

1. A method of searching and playing back video data based on caption-based information, a user interface being provided to a user for inputting a search information, and the method searching and playing back a specific section of the video data according to the search information, the method comprising the steps of:
reading caption-based information of the video data;
establishing a search table based on the caption-based information;
reading a search information;
searching the search table so as to find out the caption-based information matching to the search information;
setting a play information; and
playing the video data according to the play information.

2. The method of claim 1, wherein the search table comprises at least one sentence and its corresponding starting play queue information.

3. The method of claim 2, wherein the starting play queue information is a time value.

4. The method of claim 2, wherein the starting play queue information is a data amount.

5. The method of claim 1, wherein the step of searching the search table includes the steps of:
listing at least one matching item matching the search information; and
selecting one item from the matching item.

6. The method of claim 5, wherein each of the matching items comprises at least one word data and a time data.

7. The method of claim 5, wherein the matching item are displayed in a selection table.

8. The method of claim 7, wherein the selection table is provided for the user to make a selection.

9. The method of claim 1, wherein the user interface has an input field for the user to enter the search information.

10. A method of playing video data by word searching for a user to use a search key and the caption data of video data to search and play the video data on a video playing device, the method comprising the steps of:
reading in the caption data of the video data;
detecting the depression of the search key;
reading in the time data of the current video data; and
adjusting the video data playing.

11. The method of claim 10, wherein the caption data include a plurality of sentence data.

12. The method of claim 11, wherein each of the sentence data contains corresponding starting play queue information.

13. The method of claim 12, wherein each of the sentence data has an item-attribute.

14. The method of claim 13, wherein the item-attribute is a seekable video location of numerical type.

15. The method of claim 12, wherein the step of adjusting the video data playing includes the steps of:
setting a play time according to the starting play queue information; and
playing the video data according to the playtime.

16. The method of claim 15, wherein the step of setting a playtime according to the starting play queue information uses the starting play queue information of the previous sentence as the playtime.

17. The method of claim 15, wherein the step of setting a playtime according to the starting play queue information uses the starting play queue information of the next sentence as the playtime.
